(19) United States
(12) Patent Application Publication
(10) Pub. No.: US 2012/0281042 A1
(43) Pub. Date: Nov. 8, 2012

(54) Ink Jet Printer Cleaning Solution

(76) Inventors: Casey Walker, (US); Timothy Bradley, Longmont, CO (US); Constantino Tadiello, Fort Collins, CO (US)

(21) Appl. No.: 13/098,960

(22) Filed: May 2, 2011

(51) Int. Cl. B41J 2/165; C11D 3/43

(52) U.S. Cl. 347/28; 510/170

(57) ABSTRACT

An ink jet print head cleaning solution is disclosed. The cleaning solution comprises water and a non-ionic seed oil surfactant.

### FIELD OF THE INVENTION

This invention relates generally to the field of ink jet printing systems. More particularly, the invention relates to a cleaning liquid for an ink jet printing system.

### BACKGROUND

An ink jet printer is an example of a printing apparatus that ejects droplets of ink onto a recording medium, such as a sheet of paper, for printing an image on the recording medium. The ink jet printer includes a print engine having one or more ink jet print heads provided with an ink cartridge that accommodates the ink. In operation of the print engine, the ink is supplied from the ink cartridge to each ink jet print head having ejection nozzles, so that a printing operation is performed by ejection of the ink droplets from selected ejection nozzles.

However, ink jet printers may suffer from one or more problems leading to nozzle clogging and the inability to fire an ink droplet under normal conditions. One such problem is attributed to the formation of micro bubbles that form on the surface of the nozzles during print head operation. A clogged nozzle may result in diminished print quality. Thus, ink jet print heads are regularly maintained to ensure usability.

Maintenance of ink jet print heads may involve replacing ink with a cleaning liquid, such as Epson Cleaning Solution, in order to remove clogs of dried ink and impurities from the nozzles. Nevertheless, such cleaning liquids are not effective in removing micro bubbles. Accordingly, the formation of micro bubbles in nozzles often requires the expense of replacing an entire ink jet print head that has clogged nozzles attributed to micro bubbles.

Therefore, a cleaning liquid effective in removing micro bubbles from inkjet nozzles is desired.

### SUMMARY

In one embodiment, an ink jet print head cleaning solution is disclosed comprising water and a non-ionic seed oil surfactant.

In a further embodiment, a system is disclosed. The system includes a print head having one or more ink channels, one or more hoses coupled to the print head and a maintenance station coupled to the hoses to provide the cleaning solution to flush the ink channels.

In yet a further embodiment a method is disclosed including providing the cleaning solution to flush the ink jet print head to disintegrate micro bubbles formed in the ink jet print head.

### BRIEF DESCRIPTION OF THE DRAWINGS

A better understanding of the present invention can be obtained from the following detailed description in conjunction with the following drawings, in which:

FIG. 1 illustrates one embodiment of a system; and

FIG. 2 illustrates one embodiment of a print head ink jet channel.

### DETAILED DESCRIPTION

A cleaning liquid for an ink jet print head is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

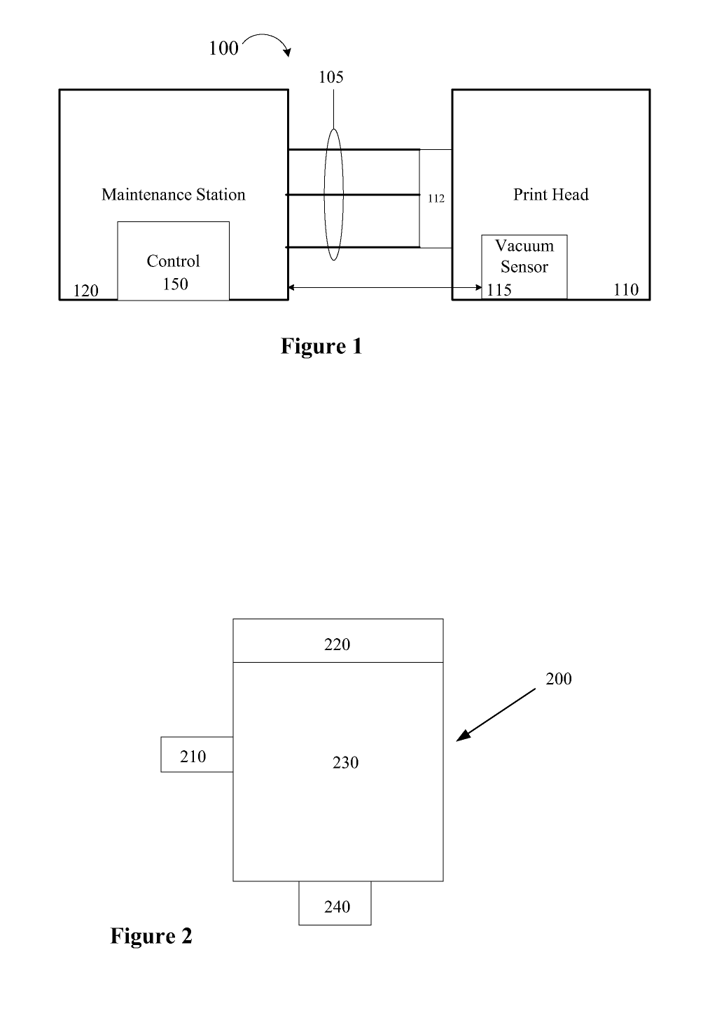

FIG. 1 illustrates one embodiment of a system 100. System 100 includes a print head 110 and a maintenance station 120. Maintenance station 120 is coupled to print head 110 by caps 112, which attach to print head 110, and hoses 105. Maintenance station 120 is used to maintain print head 110 by pulling ink through and from print head 110 to maintenance station 120 via a vacuum source. Further, an ambient air system is implemented to relieve the vacuum prior to uncapping a capped print head after vacuum has been applied through the maintenance station.

In one embodiment, print head 110 is a component of an ink jet print engine that supplies ink from an ink cartridge to a medium via a multitude ink channels each including a nozzle. FIG. 2 illustrates one embodiment of an ink jet channel 200. Channel 200 includes a reservoir 210, piezo 220 and nozzle 240. During operation, piezo 220 receives an electric charge that causes it to vibrate. Upon vibrating inward, piezo 220 forces ink out of nozzle 240. When piezo 220 vibrates out, additional ink is pulled into reservoir 210 to replace the ink sprayed through nozzle 240.

However the vibrations caused by piezo 200 often results in the formation of micro bubbles of ink in nozzle 240. Over time, the magnitude of bubbles generated leads to the failure of ink jet channel 200. A main contributing factor to the micro bubble stability is high surface tension, in which molecules on the surface of the ink liquid have a higher lateral attraction than molecules in the middle. Thus, the micro bubbles are difficult to disintegrate.

According to one embodiment, maintenance station 120 is implemented to provide a cleaning solution to flush print head 110 in order to remove micro bubbles and other types of nozzle clogs. In one embodiment, the cleaning solution includes a seed oil based non-ionic surfactant. The addition of a seed oil based surfactant introduces surface active agents that lower the interfacial tension between the ink molecules in print head 110. Lowering the interfacial tension lowers the surface tension of micro bubbles and weakens the molecule bond, making the bubbles unstable and in condition to be burst.

In one embodiment, the seed oil based surfactant comprises a modified seed oil and alcohol ethoxylate chemical composition. Commercially available modified seed oil, alcohol ethoxylate compositions may also be implemented. For instance, the biodegradable Ecosurf SA surfactants (e.g., Ecosurf SA-4, SA-7, SA-9 and SA-15) manufactured by Dow Chemical may be implemented. In one embodiment, the maintenance solution includes a composition of 1% by weight Ecosurf SA surfactant in water. However other surfactant/water ratios may be implemented in other embodiments.

The low foam factor of the Ecosurf SA surfactants results in a reduced quantity of bubbles forming in ink jet lines during the maintenance flushing. The above-described mechanism extends the life of print heads by ensuring that micro bubbles formed in the print heads are removed during maintenance.

What is claimed is:

1. An ink jet print head cleaning solution comprising water and a non-ionic seed oil surfactant.

2. The cleaning solution of claim 1 wherein the non-ionic seed oil surfactant comprises modified seed oil and alcohol ethoxylate.

3. The cleaning solution of claim 2 wherein the non-ionic seed oil surfactant is biodegradable.

4. The cleaning solution of claim 2 wherein the non-ionic seed oil surfactant comprises an Ecosurf SA surfactant.

5. The cleaning solution of claim 1 wherein the non-ionic seed oil surfactant comprises 1% by weight of the cleaning solution.

6. The cleaning solution of claim 1 wherein the non-ionic seed oil surfactant disintegrate ink micro bubbles formed in the ink jet print head.

7. A system comprising:
a print head having one or more ink channels;
one or more hoses coupled to the print head; and
a maintenance station coupled to the hoses to provide a cleaning solution to flush the ink channels, wherein the cleaning solution comprises water and a non-ionic seed oil surfactant.

8. The system of claim 7 wherein the non-ionic seed oil surfactant comprises modified seed oil and alcohol ethoxylate.

9. The system of claim 8 wherein the non-ionic seed oil surfactant is biodegradable.

10. The system of claim 8 wherein the non-ionic seed oil surfactant comprises an Ecosurf SA surfactant.

11. The system of claim 7 wherein the non-ionic seed oil surfactant comprises 1% by weight of the cleaning solution.

12. The system of claim 7 wherein the non-ionic seed oil surfactant disintegrate ink micro bubbles formed in the ink jet print head.

13. A method comprising providing a cleaning solution to flush an ink jet print head to disintegrate micro bubbles formed in the ink jet print head, wherein the cleaning solution comprises water and a non-ionic seed oil surfactant.

14. The method of claim 13 wherein the non-ionic seed oil surfactant comprises modified seed oil and alcohol ethoxylate.

15. The method of claim 14 wherein the non-ionic seed oil surfactant is biodegradable.

16. The method of claim 14 wherein the non-ionic seed oil surfactant comprises an Ecosurf SA surfactant.

17. The method of claim 13 wherein the non-ionic seed oil surfactant comprises 1% by weight of the cleaning solution.
